(19) United States
(12) Patent Application Publication
(10) Pub. No.: US 2025/0173953 A1
(43) Pub. Date: May 29, 2025

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventor: Yuichi NAKADA, Kanagawa (JP)

(21) Appl. No.: 18/931,207

(22) Filed: Oct. 30, 2024

(30) Foreign Application Priority Data
Nov. 28, 2023 (JP) 2023-200974

(51) Int. Cl. G06T 15/20; G06T 7/55

(52) U.S. Cl. CPC G06T 15/205; G06T 7/55

(57) ABSTRACT

The image quality of a virtual viewpoint image is improved. The image processing apparatus according to the present disclosure obtains data of a plurality of captured images obtained by capturing an object from a plurality of directions and virtual viewpoint information relating to a position of a virtual viewpoint and a viewing direction at the virtual viewpoint, sets a generation scheme of a virtual viewpoint image based on features of the object, which are obtained based on the virtual viewpoint information, and generates the virtual viewpoint image based on the virtual viewpoint information and the set generation scheme of the virtual viewpoint image.

### FIELD

The present disclosure relates to an image processing technique to generate a virtual viewpoint image.

### DESCRIPTION OF THE RELATED ART

There is a technique to estimate the shape of an object by using a plurality of captured images obtained by capturing the object from a variety of directions and reconstruct an image (virtual viewpoint image) corresponding to an image in a case where the object is viewed from an arbitrary virtual viewpoint. However, there is a case where it is not possible to accurately estimate the shape of an object (in the following, called “object shape”) resulting from the occurrence of a captured image not including the image of the object depending on the position of the object, and therefore, the image quality of a virtual viewpoint image is reduced. Japanese Patent Laid-Open No. 2023-075859 (in the following, called “Patent Document 1”) has disclosed a technique to select a generation method of a virtual viewpoint image that is output based on the position of an object. Specifically, the technique disclosed in Patent Document 1 outputs a virtual viewpoint image that is generated by using the object shape in a case where the object is located in an area that is captured by a plurality of imaging apparatuses. On the other hand, in a case where the object is located in an area that is not captured by part of the imaging apparatuses among the plurality of imaging apparatuses, a virtual viewpoint image that is generated without using the object shape is output.

### SUMMARY

However, even though an object is located in an area that is captured by a plurality of imaging apparatuses, in a case where the object shape that is viewed from a virtual viewpoint is complicated, and the like, it is not possible to accurately estimate the object shape, and therefore, it may happen sometimes that the image quality of a virtual viewpoint image is reduced.

In the present disclosure, a technique capable of generating a virtual viewpoint image of high image quality even, for example, in the above-described case is disclosed.

The image processing apparatus according to the present disclosure includes: one or more hardware processors; and one or more memories storing one or more programs configured to be executed by the one or more hardware processors, the one or more programs including instructions for: obtaining data of a plurality of captured images obtained by capturing an object from a plurality of directions; obtaining virtual viewpoint information relating to a position of a virtual viewpoint and a viewing direction at the virtual viewpoint; setting a generation scheme of a virtual viewpoint image based on features of the object, which are obtained based on the virtual viewpoint information; and generating the virtual viewpoint image based on the virtual viewpoint information and the set generation scheme of the virtual viewpoint image.

Further features of various embodiments will become apparent from the following description of exemplary embodiments with reference to the attached drawings.

### BRIEF DESCRIPTION OF THE DRAWINGS

FIG. 1 is a diagram showing one example of a configuration of an image processing system according to Embodiment 1;

FIG. 2 is a block diagram showing one example of a hardware configuration of an image processing apparatus according to Embodiment 1;

FIG. 3 is a block diagram showing one example of a function configuration of the image processing apparatus according to Embodiment 1;

FIG. 4 is a flowchart showing one example of a processing flow of the image processing apparatus according to Embodiment 1;

FIG. 5A is a diagram showing one example of arrangement of imaging apparatuses according to Embodiment 1 and FIG. 5B to FIG. 5D are each a diagram showing one example of a captured image that is obtained by image capturing by the imaging apparatus;

FIG. 6 is a flowchart showing one example of a flow of setting processing of a rendering scheme in a scheme setting unit according to Embodiment 1;

FIG. 7 is a diagram showing one example of an approximate shape of an object according to Embodiment 1;

FIG. 8A to FIG. 8C are each a diagram showing one example of a lookup table that is used by the scheme setting unit according to Embodiment 1;

FIG. 9 is a flowchart showing one example of a flow of generation processing of a virtual viewpoint image in an image generation unit according to Embodiment 1;

FIG. 10 is a flowchart showing one example of a flow of generation processing of a virtual viewpoint image in an image generation unit according to Modification example 1 of Embodiment 1;

FIG. 11A is a diagram showing one example of arrangement of imaging apparatuses according to Embodiment 2 and FIG. 11B to FIG. 11F are each a diagram showing one example of a captured image that is obtained by image capturing by the imaging apparatus;

FIG. 12A and FIG. 12B are each a diagram showing one example of a lookup table that is used by a scheme setting unit according to Embodiment 2; and

FIG. 13 is a diagram showing one example of arrangement of imaging apparatuses according to Modification example 1 of Embodiment 2.

### DESCRIPTION OF THE EMBODIMENTS

Hereinafter, with reference to the attached drawings, the present disclosure is explained in detail in accordance with preferred embodiments. Configurations shown in the following embodiments are merely exemplary and the present disclosure is not limited to the configurations shown schematically.

### Embodiment 1

In Embodiment 1, an aspect is explained in which a rendering scheme (generation scheme) is set based on features of an object in a case where the object is viewed from a virtual viewpoint and a virtual viewpoint image corresponding to the virtual viewpoint is generated by the set rendering scheme. For the generation of a virtual viewpoint image, data of a plurality of captured images (in the following, called “multi-viewpoint images”) obtained by image capturing from a variety of directions by a plurality of imaging apparatuses. The rendering scheme of a virtual viewpoint image is set based on the complicatedness of the shape of an object in a case where the object is viewed from a virtual viewpoint and the size of the object that is included as an image per pixel in a virtual viewpoint image in a case where the virtual viewpoint image corresponding to the virtual viewpoint is generated. In the following, explanation is given by describing “size of an object included as an image per pixel” as “object size per pixel”.

As the rendering scheme of a virtual viewpoint image, either the rendering scheme based on object shape or the rendering scheme based on radiance fields is set. In a case where a virtual viewpoint image is generated as a moving image, the rendering scheme is set for each frame of a virtual viewpoint image. Further, in Embodiment 1, explanation is given on the assumption that the focal length of all the imaging apparatuses is equal to one another.

### <Configuration of Image Processing System>

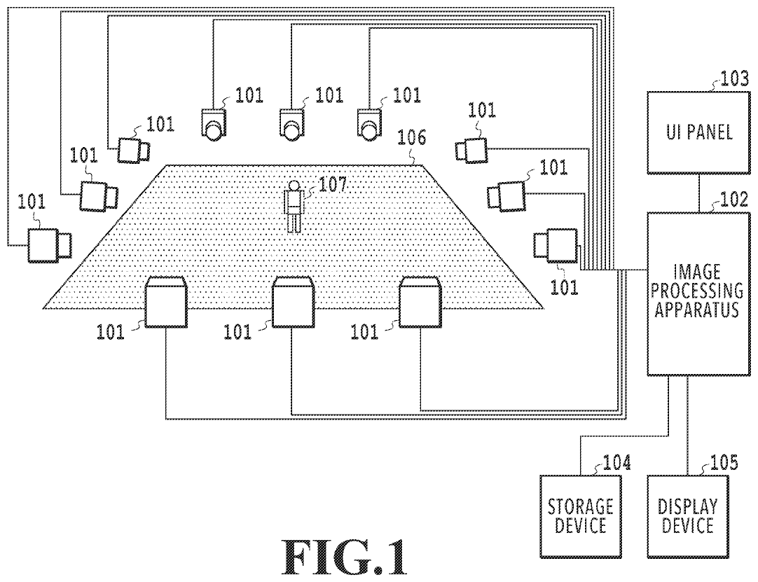

FIG. 1 is a diagram showing one example of the configuration of an image processing system according to Embodiment 1. The image processing system according to Embodiment 1 has a plurality of imaging apparatuses 101, an image processing apparatus 102, a user interface (in the following, described as “UI”) panel 103, a storage device 104, and a display device 105. The plurality of the imaging apparatuses 101 performs image capturing in synchronization with one another for an object 107 existing in an image capturing area 106 in accordance with image capturing conditions and outputs the data of captured images (in the following, called “captured image data”) obtained by the image capturing to the image processing apparatus 102. The image processing apparatus 102 obtains a plurality of pieces of captured image data (multi-viewpoint image data) that is output from the plurality of the imaging apparatuses 101 and generates a virtual viewpoint image using the obtained multi-viewpoint image data. The data or signal of the virtual viewpoint image generated by the image processing apparatus 102 is output to an external device.

The UI panel 103 comprises a display device, such as a liquid crystal display, and displays a user interface for presenting image capturing conditions of the imaging apparatus 101, processing settings of the image processing apparatus 102 and the like on the display device. The UI panel 103 may comprise an input device, such as a touch panel or a button, and in this case, the UI panel 103 receives instructions from a user about changes in the above-described image capturing conditions, the processing settings and the like. In a case where the input device receives instructions from a user, the UI panel 103 transmits information indicating the instructions to the image processing apparatus 102. The input device may be provided separately from the UI panel 103 like a mouse, a keyboard or the like. The storage device 104 stores the data of a virtual viewpoint image that is output by the image processing apparatus 102. The display device 105 includes a liquid crystal display or the like and receives a signal indicating a virtual viewpoint image that is output from the image processing apparatus 102 and displays the virtual viewpoint image.

### <Hardware Configuration of Image Processing Apparatus>

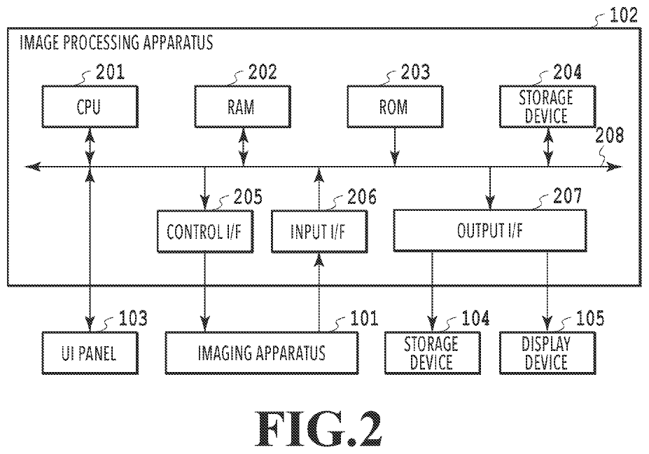

FIG. 2 is a block diagram showing one example of the hardware configuration of the image processing apparatus 102 according to Embodiment 1. The image processing apparatus 102 has, as hardware configurations, a CPU 201, a RAM 202, a ROM 203, a storage device 204, a control interface (in the following, described as “I/F”) 205, an input I/F 206, an output I/F 207, and a main bus 208. The CPU 201 is a processor that comprehensively controls each unit of the image processing apparatus 102. The RAM 202 functions as a main memory, a work area and the like of the CPU 201. The ROM 203 stores one or more programs that are executed by the CPU 201. The storage device 204 includes a hard disk drive or the like and stores application programs that are executed by the CPU 201, data that is used for the processing of the CPU 201, and the like.

The control I/F 205 is connected with each imaging apparatus 101 and is a communication interface for performing control, such as the setting of image capturing conditions for each imaging apparatus 101, the start of image capturing, and the termination of image capturing. The input I/F 206 is a communication interface by a serial bus, such as SDI (Serial Digital Interface) or HDMI (registered trademark) (High-Definition Multimedia Interface (registered trademark)), and the like. Via the input I/F 206, captured image data is obtained from each imaging apparatus 101. The output I/F 207 is a communication interface by a serial bus, such as USB (Universal Serial Bus) or DP (DisplayPort (registered trademark)), and the like. Via the output I/F 207, the data of a virtual viewpoint image or the signal indicating a virtual viewpoint image is output to the storage device 104 or the display device 105. The main bus 208 is a transmission path connecting the above-described hardware configurations of the image processing apparatus 102 to one another so as to be capable of communication.

### <Function Configuration of Image Processing Apparatus>

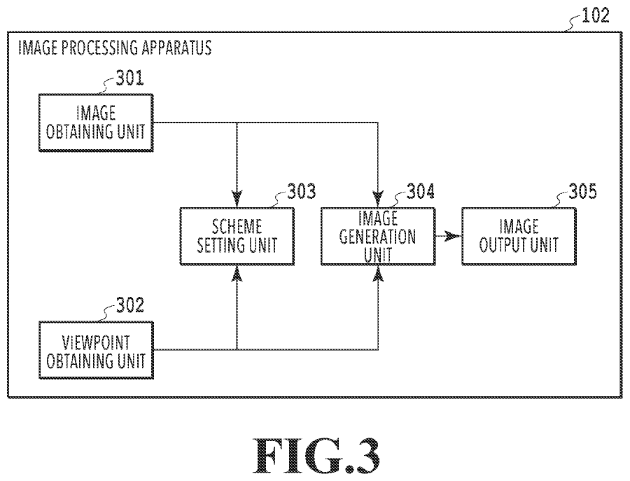

FIG. 3 is a block diagram showing one example of the function configuration of the image processing apparatus 102 according to Embodiment 1. The image processing apparatus 102 has, as function configurations, an image obtaining unit 301, a viewpoint obtaining unit 302, a scheme setting unit 303, an image generation unit 304, and an image output unit 305. The image obtaining unit 301 obtains captured image data and camera parameters (in the following, called “image capturing camera parameters”) corresponding to the captured image data from each imaging apparatus 101 that captures the object 107. The viewpoint obtaining unit 302 obtains information (in the following, called “virtual camera parameters”) indicating the position of a virtual viewpoint, the viewing direction at a virtual viewpoint and the like, which corresponds to the camera parameters of an imaging apparatus (in the following, called “virtual camera”) that is arranged virtually at the virtual viewpoint.

The scheme setting unit 303 sets the rendering scheme in a case where a virtual viewpoint image is generated based on the features of the object 107 viewed from a virtual viewpoint. Specifically, first, the scheme setting unit 303 specifies the features of the object 107 based on the captured image data corresponding to each imaging apparatus 101, which is obtained by the image obtaining unit 301, the image capturing camera parameters, and the virtual camera parameters obtained by the viewpoint obtaining unit 302. Following this, the scheme setting unit 303 determines the rendering scheme based on the specified features of the object 107 and sets the determined rendering scheme. The image generation unit 304 generates a virtual viewpoint image corresponding to an image in a case where the image capturing area 106 is viewed from the virtual viewpoint by the rendering scheme set by the scheme setting unit 303. Specifically, the image generation unit 304 generates a virtual viewpoint image by the set rendering scheme by using the captured image data corresponding to each imaging apparatus 101, which is obtained by the image obtaining unit 301, the image capturing camera parameters, and the virtual camera parameters obtained by the viewpoint obtaining unit 302. The image output unit 305 outputs the data of the virtual viewpoint image or the signal indicating the virtual viewpoint image to the storage device 104, the display device 105 or the like.

### <Operation of Image Processing Apparatus>

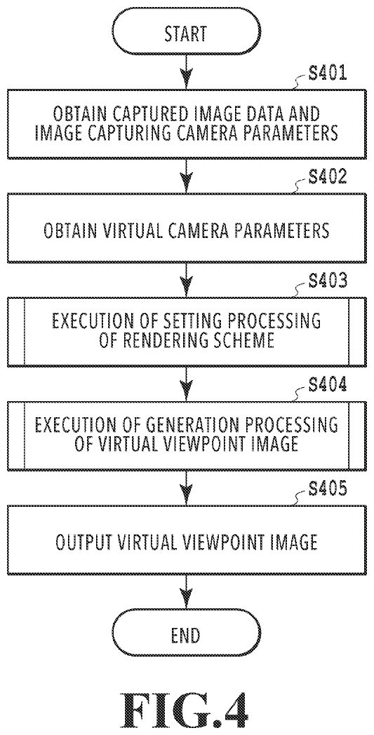

FIG. 4 is a flowchart showing one example of a processing flow of the image processing apparatus 102 according to Embodiment 1. Here, “S” attached to the top of a symbol means a step (process). Further, the processing at each step shown in the flowchart in FIG. 4 is implemented by the CPU 201 reading a predetermined program from the ROM 203 or the storage device 204, loading the program onto the RAM 202, and executing the program.

First, at S401, the image obtaining unit 301 obtains captured image data and image capturing camera parameters corresponding to the captured image data from each imaging apparatus 101 via the input I/F 206. The source from which the captured image data and the image capturing camera parameters are obtained is not limited to the imaging apparatus 101. For example, it may also be possible for the image obtaining unit 301 to obtain the captured image data or the image capturing camera parameters by reading them from the storage device 104 or the storage device 204 storing them in advance. Specifically, for example, in a case where the image capturing camera parameters are calculated in advance by calibration or the like and stored in the storage device 204, the image obtaining unit 301 obtains the image capturing camera parameters by reading them from the storage device 204. The captured image data and the image capturing camera parameters obtained by the image obtaining unit 301 are associated with each other and stored in the RAM 202.

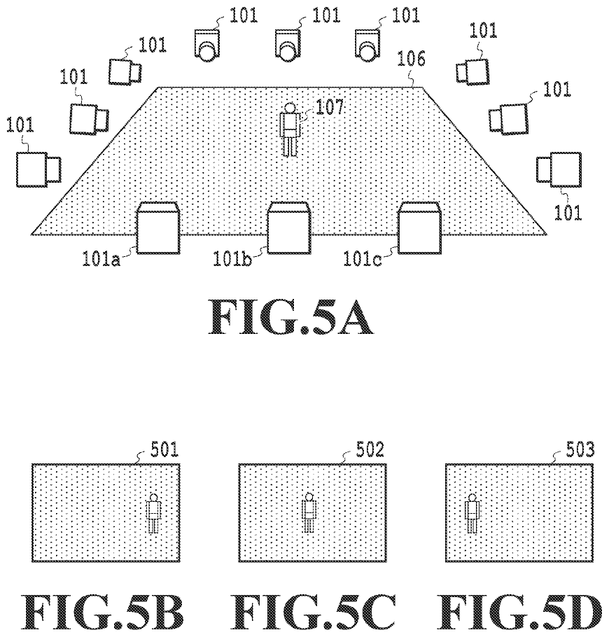

FIG. 5A is a diagram showing one example of the arrangement of the imaging apparatuses 101 according to Embodiment 1 and FIG. 5B to FIG. 5D are each a diagram showing one example of a captured image obtained by image capturing by the imaging apparatus 101. FIG. 5A shows one example of the arrangement of each imaging apparatus 101 and the plurality of the imaging apparatuses 101 is arranged so as to be capable of capturing the object 107 existing in the image capturing area 106 from a variety of directions. Imaging apparatuses 101a, 101b, and 101c shown in FIG. 5A are the same as the other imaging apparatuses 101. FIG. 5B shows one example of a captured image 501 that is obtained by image capturing by the imaging apparatus 101a, FIG. 5C shows one example of a captured image 502 that is obtained by image capturing by the imaging apparatus 101b, and FIG. 5D shows one example of a captured image 503 that is obtained by image capturing by the imaging apparatus 101c, respectively. In Embodiment 1, explanation is given on the assumption that the focal length of all the imaging apparatuses 101 including the imaging apparatuses 101a, 101b, and 101c is equal to one another.

After S401, at S402, the viewpoint obtaining unit 302 obtains virtual camera parameters. The virtual camera parameters may be one that is set based on instructions from the UI panel 103, or may be one that is set in advance and stored in advance in the storage device 204. Next, at S403, the scheme setting unit 303 performs setting processing of a rendering scheme. The scheme setting unit 303 sets the rendering scheme in a case where a virtual viewpoint image is generated by performing the setting processing. Details of the setting processing of the rendering scheme at S403 will be described later. After S403, at S404, the image generation unit 304 performs the generation processing of a virtual viewpoint image. The image generation unit 304 generates a virtual viewpoint image corresponding to the virtual viewpoint indicated by the virtual camera parameters obtained at S402 by performing the generation processing. Details of the generation processing of a virtual viewpoint image at S404 will be described later. After S404, at S405, the image output unit 305 outputs the data of the virtual viewpoint image or the signal indicating the virtual viewpoint image to the storage device 104 or the display device 105 via the output I/F 207. After S405, the image processing apparatus 102 terminates the processing of the flowchart shown in FIG. 4.

### <Setting Processing of Rendering Scheme>

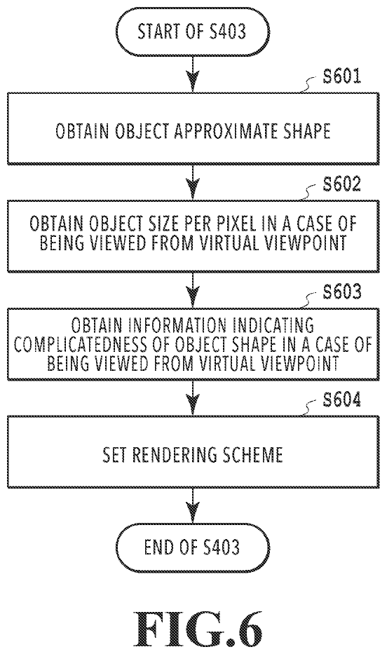

FIG. 6 is a flowchart showing one example of a flow of the setting processing of a rendering scheme in the scheme setting unit 303 according to Embodiment 1 and is a flowchart showing one example of a flow of the processing at S403. The scheme setting unit 303 sets the rendering scheme in a case where a virtual viewpoint image is generated based on the features of the object 107 in a case where the object 107 is viewed from the virtual viewpoint by performing the processing of the flowchart.

After S402 shown in FIG. 4, at S601, the scheme setting unit 303 obtains an approximate shape of the object 107 based on a plurality of pieces of captured image data and the image capturing camera parameters corresponding to each piece of the captured image data, which are obtained at S401. For example, the scheme setting unit 303 obtains information represented as a set of voxels by the visual hull method as an approximate shape of the object 107.

Specifically, at S601, the scheme setting unit 303 first obtains the data of a captured image (in the following, called “background image”) obtained by each imaging apparatus 101 capturing in advance only the image capturing area 106 corresponding to the background in a state where the object 107 does not exist. Following this, at S601, the scheme setting unit 303 generates a silhouette image of the object 107, which corresponds to each captured image, based on the difference between the background image corresponding to each imaging apparatus 101 and the captured image corresponding to the background image, which is obtained at S401. Following this, at S601, the scheme setting unit 303 projects each voxel onto each generated silhouette image, which is included in a set of voxels within a virtual space corresponding to the image capturing area 106 based on the image capturing camera parameters. Following this, at S601, the scheme setting unit 303 obtains the set of voxels projected onto the silhouette of the object 107 for all the silhouette images as an approximate shape.

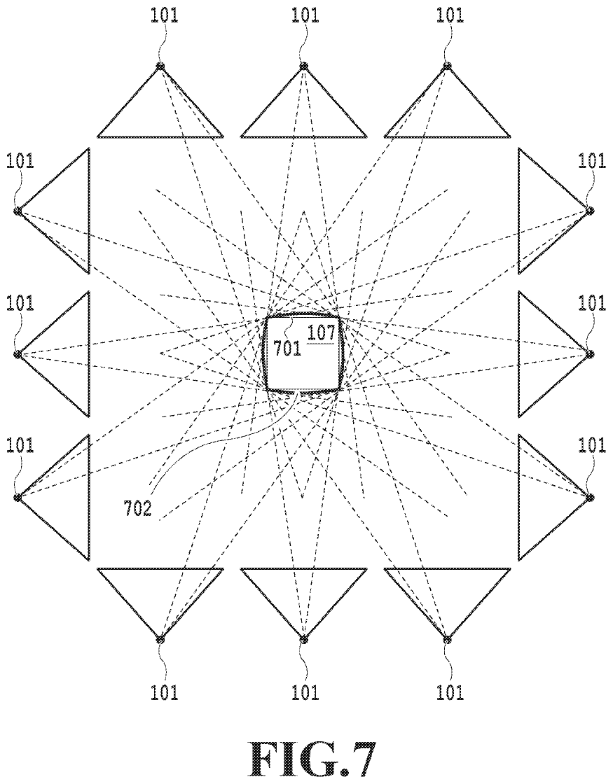

FIG. 7 is a diagram showing one example of an approximate shape of the object 107, which is obtained by the visual hull method according to Embodiment 1. In FIG. 7, each broken line extending from each imaging apparatus 101 indicates a boundary in a case where the external shape of the area corresponding to the object 107 in each silhouette image is projected onto each voxel included in the set of the voxels within the virtual space. Further, in FIG. 7, a polygon 701 indicated by a thin line indicates the surface of the object 107 and a polygon 702 indicated by a thick line indicates an approximate shape of the object 107, which is obtained by the visual hull method.

After S601, at S602, the scheme setting unit 303 obtains the object size per pixel in the virtual viewpoint image corresponding to the image in a case where the object 107 is viewed from the virtual viewpoint based on the object approximate shape obtained at S601. Here, “object size per pixel in a virtual viewpoint image corresponding to an image in a case of being viewed from the virtual viewpoint” means “object size per pixel in a virtual viewpoint image in a case where the virtual viewpoint image corresponding to the virtual viewpoint is generated”. In the following, explanation is given by calling “object size per pixel in a virtual viewpoint image corresponding to an image in a case where the object 107 is viewed from the virtual viewpoint” simply “object size per pixel in a case of being viewed from the virtual viewpoint”. In Embodiment 1, the coordinates of the center of gravity of the approximate shape of the object 107, which is represented as a set of voxels, are taken to be the representative point and the object size per pixel in a case of being viewed from the virtual point is obtained based on the representative point and the virtual camera parameters. Specifically, for example, the object size per pixel may be calculated by using mathematical formula (1).

s=d/F mathematical formula (1)

Here, s is the object size per pixel and d is the distance from the virtual camera to the representative point in a case where the representative point of the approximate shape of the object 107 is projected in the optical axis direction of the virtual camera, that is, in the viewing direction at the virtual viewpoint. Further, F indicates the focal length of the virtual camera. The focal length of the virtual camera is a value into which converted for each pixel based on the size of the pixel in the virtual viewpoint image that is obtained by pseud image capturing by the virtual camera.

After S602, at S603, the scheme setting unit 303 obtains information indicating the complicatedness of the object shape in a case where the object 107 is viewed from the virtual viewpoint based on the object approximate shape obtained at S601. It is possible to obtain information indicating the complicatedness of the object shape by the following method as one example. At S603, first, the scheme setting unit 303 selects the two imaging apparatuses 101 from among the plurality of the imaging apparatuses 101, whose optical axis direction is the same (“the same” here includes “substantially the same”) as the viewing direction at the virtual viewpoint, or whose optical axis direction is the closest to the viewing direction at the virtual viewpoint.

Following this, at S603, the scheme setting unit 303 selects one of two captured images obtained by the two selected imaging apparatuses 101 capturing the object 107 as a reference image and the other as a target image. Following this, at S603, the scheme setting unit 303 obtains the pixel values of the pixels corresponding to each other in the areas corresponding to the approximate shapes in the reference image and the target image in a case where the target image is projected onto the reference image based on the approximate shape of the object 107. Following this, at S603, the scheme setting unit 303 obtains the difference between the obtained pixel values by regarding it as a value indicating the complicatedness of the object shape. Specifically, for example, it is possible to calculate the value indicating the complicatedness of the object shape by using mathematical formula (2).

c=((Σᵢ((y′ᵢ−yᵢ)²))/n)^{1/2} mathematical formula (2)

Here, c is the value indicating the complicatedness of the object shape. Further, yᵢ is the luminance value of a pixel (i) included in the area corresponding to the approximate shape of the object 107 in the reference image. Further, y′ᵢ is the luminance value of the pixel corresponding to the pixel (i) of the reference image, which is included in the area corresponding to the object 107 in the target image in a case where the target image is projected onto the reference image based on the approximate shape. Further, n is the number of pixels included in the area corresponding to the object 107 in the reference image and the target image. In mathematical formula (2), as one example, a root mean square is calculated by using the luminance value of the pixel included in the area corresponding to the object 107 in the reference image and the target image and taken to be the value (c) indicating the complicatedness of the object shape. However, the calculation method of the value (c) is not limited to this and simple averaging and the like may also be used.

The more complicated the actual shape of the object 107, the more difficult it becomes to accurately represent the actual shape of the object 107 by the approximate shape of the object 107. Because of this, the more complicated the actual shape of the object 107, the harder it becomes to accurately project the target image onto the reference image. Consequently, the more complicated the actual shape of the object 107, the larger becomes the value (c) indicating the complicatedness of the object shape, which is calculated by the root mean square.

After S603, at S604, the scheme setting unit 303 sets the rendering scheme of a virtual viewpoint image based on the object size(s) per pixel in a case of being viewed from the virtual viewpoint and the value (c) indicating the complicatedness of the object shape. Specifically, the scheme setting unit 303 sets either the rendering scheme based on shape or the rendering scheme based on radiance fields as the rendering scheme of a virtual viewpoint image based on the object size(s) and the value (c) indicating the complicatedness. Details of each rendering scheme will be described later. The quality of a virtual viewpoint image that is generated by the image processing apparatus 102 based on multi-viewpoint image data will be as follows in accordance with the features of the object 107 in a case of being viewed from the virtual viewpoint. In a case where the object shape is complicated and the object size per pixel is small, the quality of a virtual viewpoint image that is generated by the rendering scheme based on shape is reduced. In the cases other than this case, the quality of a virtual viewpoint image that is generated by the above-described two rendering schemes will be substantially equal irrespective of the rendering scheme.

It is generally known that the calculation amount necessary for generating a virtual viewpoint image is small in the rendering scheme based on shape compared to that in the rendering scheme based on radiance fields. Consequently, the scheme setting unit 303 determines and sets the rendering scheme as follows. The scheme setting unit 303 first judges that the level of the object size is “large” in a case where the object size(s) per pixel in a case of being viewed from the virtual viewpoint is larger than or equal to a first threshold value (tₛ). Further, the scheme setting unit 303 judges that the level of the object size is “small” in a case where the object size(s) is less than the first threshold value (tₛ). Further, the scheme setting unit 303 judges that the level of the complicatedness of the object shape is “complicated” in a case where the value (c) indicating the complicatedness of the object shape in a case of being viewed from the virtual viewpoint is larger or equal to a second threshold value (t_{c}). Further, the scheme setting unit 303 judges that the level of the complicatedness of the object shape is “simple” in a case where the value (c) indicating the complicatedness is less than the second threshold value (t_{c}).

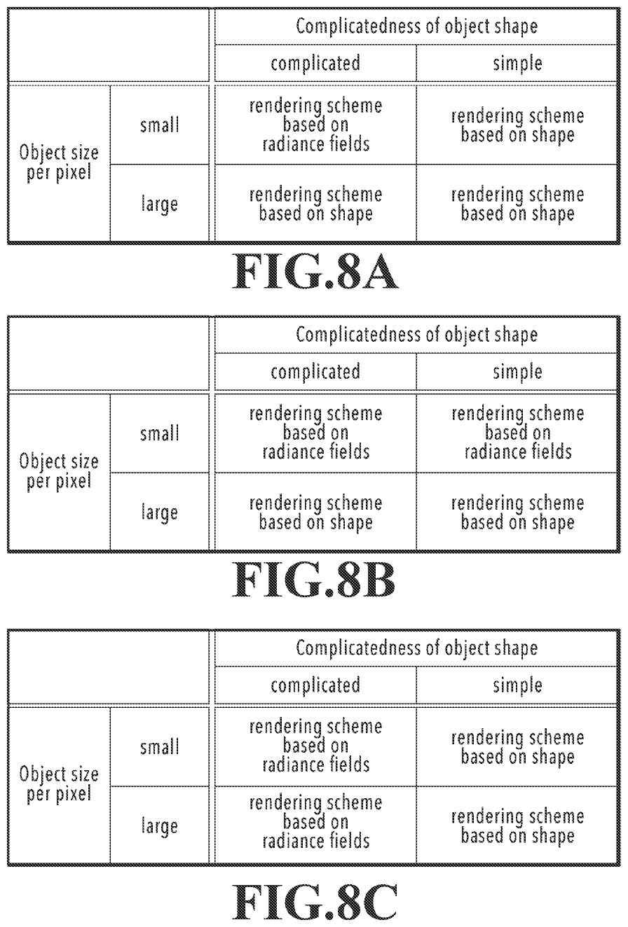

FIG. 8A to FIG. 8C are each a diagram showing one example of a lookup table (in the following, described as “LUT”) that is used in a case where the scheme setting unit 303 according to Embodiment 1 sets a rendering scheme. In the LUT shown in FIG. 8A to FIG. 8C, the rendering scheme, the level of the object size per pixel in a case of being viewed from the virtual viewpoint, and the level of the complicatedness of the object shape in a case of being viewed form the virtual viewpoint are managed in association with one another. The scheme setting unit 303 according to Embodiment 1 determines and sets the rendering scheme of a virtual viewpoint image in accordance with the level of the object size and the level of the complicatedness of the object shape by using the LUT shown in FIG. 8A.

Specifically, the scheme setting unit 303 sets the rendering scheme based on radiance fields as the rendering scheme of a virtual viewpoint image only in a case where the level of the complicatedness of the object shape is “complicated” and the level of the object size per pixel is “small”. In the cases other than this case, the scheme setting unit 303 sets the rendering scheme based on shape as the rendering scheme of a virtual viewpoint image. The first threshold value (tₛ) and the second threshold value (t_{c}) may be predefined values or may be values set based on the instructions from a user, which are obtained via the UI panel 103 or the like. After the processing at S604, the scheme setting unit 303 terminates the processing of the flowchart shown in FIG. 6, that is, the processing at S403 shown in FIG. 4. The LUT shown in FIG. 8B and FIG. 8C will be described later.

### <Generation Processing of Virtual Viewpoint Image>

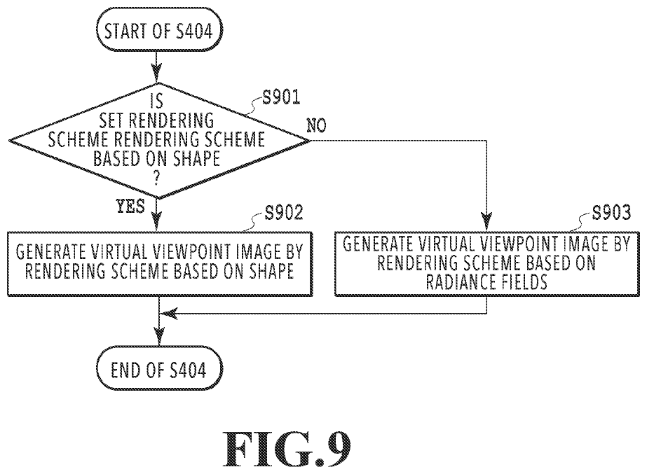

The image generation unit 304 generates a virtual viewpoint image corresponding to the virtual viewpoint indicated by the virtual camera parameters by the rendering scheme set at S403 by using the multi-viewpoint image data obtained at S401 and the virtual camera parameters obtained at S402. In the following, with reference to FIG. 9, details of the generation processing of a virtual viewpoint image in the image generation unit 304 are explained. FIG. 9 is a flowchart showing one example of a flow of the generation processing of a virtual viewpoint image in the image generation unit 304 according to Embodiment 1 and is a flowchart showing one example of a flow of the generation processing of a virtual viewpoint image at S404 shown in FIG. 4.

After S403 shown in FIG. 4, at S901, the image generation unit 304 judges whether or not the rendering scheme set at S403 is the rendering scheme based on shape. In a case where it is judged that the set rendering scheme is the rendering scheme based on shape at S901, the image generation unit 304 generates a virtual viewpoint image corresponding to the virtual viewpoint by using multi-viewpoint image data by the rendering scheme based on shape at S902. In Embodiment 1, explanation is given on the assumption that the image generation unit 304 generates a virtual viewpoint image corresponding to the virtual viewpoint based on the object approximate shape by the visual hull method, which is obtained at S601.

Specifically, at S902, first, the image generation unit 304 calculates, based on the virtual camera parameters, the position of the collision point between the ray corresponding to the pixel and the object approximate shape for each pixel in the virtual viewpoint image that is generated. Following this, at S902, the image generation unit 304 obtains the pixel value corresponding to the point on the captured image onto which the collision point is projected by using one or more captured images including the point within the image capturing area 106 as the image, which corresponds to the collision point, and takes the pixel value as the pixel value of the pixel in the virtual viewpoint image. In a case where there is a plurality of captured images including the point within the image capturing area 106 as the image, which corresponds to the collision point, the image generation unit 304 determines the pixel value of the pixel in the virtual viewpoint image as follows. In this case, the image generation unit 304 obtains the pixel value corresponding to the point on the captured image onto which the collision point is projected for each captured image including the point within the image capturing area 106 as the image, which corresponds to the collision point, and takes the weighted sum of a plurality of obtained pixel values as the pixel value of the pixel in the virtual viewpoint image. In a case where the weighted sum is calculated, for example, the image generation unit 304 sets a heavier weight for a captured image whose feeling of resolution is higher in the vicinity of the collision point.

By setting the weight such as this, it is possible for the image generation unit 304 to generate a virtual viewpoint image having a feeling of resolution substantially equal to that of the captured image whose feeling of resolution is the highest of the object 107 by the rendering scheme based on shape. However, in a case where the object approximate shape does not represent the actual object shape, the quality of the virtual viewpoint image is reduced. In particular, in a case where rendering is performed in a state where the object 107 is digitally zoomed in, the smaller the object size per pixel becomes, the more conspicuous the reduction in quality of the virtual viewpoint image becomes.

In a case where it is judged that the set rendering scheme is not the rendering scheme based on shape at S901, that is, in a case where the rendering scheme based on radiance fields is set at S403, the image generation unit 304 performs the processing at S903. Specifically, in this case, at S903, the image generation unit 304 generates a virtual viewpoint image corresponding to the virtual viewpoint by using multi-viewpoint image data by the rendering scheme based on radiance fields. More specifically, at S903, the image generation unit 304 generates a virtual viewpoint image corresponding to the virtual viewpoint by performing volume rendering based on the virtual camera parameters and the radiance fields corresponding to the image capturing area 106 estimated based on multi-viewpoint image data.

The radiance fields are a function that takes information indicating position and direction within the encoded image capturing area 106 as an input and information indicating color and density as an output and is represented by using multilayer perceptron. By using the multilayer perceptron, it is possible to represent color and density in accordance with position and direction irrespective of the complicatedness of an object shape. In the volume rendering, based on the color and density corresponding to the sampling point on the ray corresponding to the pixel in the virtual viewpoint image that is generated, the pixel value corresponding to each pixel is calculated. The color and density corresponding to the sampling point are obtained by inputting information indicating the position of the sampling point and the direction of the ray to the radiance fields. Further, the estimation of the radiance fields is performed by optimizing the radiance fields so that that difference between the pixel value that is obtained by performing the volume rendering based on the image capturing camera parameters and the radiance fields and the pixel value of the captured image becomes small. The optimization of the radiance fields is performed by repetitive processing that takes a predetermined number of pixels randomly extracted from all the captured images without taking into consideration the feeling of resolution as one unit.

According to the rendering scheme by radiance fields thus estimated, it is possible to generate a virtual viewpoint image of high quality irrespective of the complicatedness of an object shape. However, the feeling of resolution of the virtual viewpoint image that is generated by the rendering scheme based on radiance fields is substantially the same level as that of the average feeling of resolution in a plurality of captured images. Further, the amount of calculation necessary for the optimization of radiance fields is large.

<Effects Brought about by Image Processing Apparatus According to Embodiment 1>

As above, the image processing apparatus 102 is configured so that either the rendering scheme based on shape or the rendering scheme based on radiance fields is set as the rendering scheme of a virtual viewpoint image based on the features of the object 107 in a case of being viewed from the virtual viewpoint. Specifically, the image processing apparatus 102 is configured so that the more complicated the object shape in a case of being viewed from the virtual viewpoint, or the smaller the object size per pixel in a case of being viewed from the virtual viewpoint, the more preferentially the rendering scheme based on radiance fields is set. On the other hand, the image processing apparatus 102 is configured so that the simpler the object shape in a case of being viewed from the virtual viewpoint, or the larger the object size per pixel in a case of being viewed from the virtual viewpoint, the more preferentially the rendering scheme based on shape is set. According to the image processing apparatus 102 configured as above, it is possible to improve the image quality of the virtual viewpoint image that is obtained by rendering, and therefore, it is possible to suppress a sense of incongruity of a viewer for the image of the object 107 in a case where the viewer views the virtual viewpoint image.

### Modification Example 1 of Embodiment 1

Explanation is given on the assumption that the scheme setting unit 303 according to Embodiment 1 obtains the object approximate shape by the visual hull method at S601, but the obtaining method of the object approximate shape is not limited to the visual hull method. For example, the object approximate shape may be obtained based on distance information that is obtained by stereo matching or the like from two captured images obtained by image capturing by the two imaging apparatuses 101 adjacent to each other, or distance image data that is obtained by measurement by a depth camera. Alternatively, it may also be possible for the scheme setting unit 303 to obtain the object approximate shape by reading the object approximate shape generated in advance and stored in the storage device 204 or the like.

Further, explanation is given on the assumption that the scheme setting unit 303 according to Embodiment 1 takes the coordinates of the center of gravity of the object approximate shape as the representative point of the object approximate shape at S602, but the representative point of the object approximate shape is not limited to the coordinates of the center of gravity of the object approximate shape. For example, it may also be possible for the scheme setting unit 303 to select an arbitrary voxel from a set of voxels configuring the object approximate shape and takes the selected voxel as the representative point. Specifically, for example, it is possible for the scheme setting unit 303 to select one of a plurality of voxels that are viewed from the position of the virtual viewpoint as the representative point.

Further, explanation is given on the assumption that the scheme setting unit 303 according to Embodiment 1 calculates a root mean squared error of the luminance value of the pixel corresponding to the object 107 based on the reference image and the target image projected onto the reference image at S603. Further, explanation is given on the assumption that the scheme setting unit 303 according to Embodiment 1 obtains information indicating the complicatedness of the object by regarding the root mean squared error of the luminance value obtained by the calculation as information indicating the complicatedness of the object shape. However, the obtaining method of information indicating complicatedness is not limited to the above-described method.

For example, it is possible for the scheme setting unit 303 to use information indicating the color of a pixel, such as RGB values, in place of the luminance value of a pixel. Further, it may also be possible for the scheme setting unit 303 to calculate a mean squared error or a mean absolute error in place of the root mean squared error and obtain information indicating the complicatedness of the object shape by regarding the value obtained by the calculation as information indicating the complicatedness of the object shape. Further, it may also be possible for the scheme setting unit 303 to obtain information indicating the complicatedness of the object shape based on part of the pixels included in the area corresponding to the object 107 in place of all the pixels included in the area corresponding to the object 107. Further, it may also be possible for the scheme setting unit 303 to obtain information indicating the complicatedness of the object shape based on a plurality of target images.

Further, explanation is given on the assumption that the scheme setting unit 303 according to Embodiment 1 obtains information indicting the complicatedness of the object shape based on the object approximate shape at S603, but the obtaining method of information indicating complicatedness is not limited to the method based on the object approximate shape. For example, it may also be possible for the scheme setting unit 303 to project an area whose shape is complicated, such as a face, which is detected from a plurality of captured images, onto a three-dimensional space and obtain information indicating the complicatedness of the object shape by regarding the number of areas whose shape viewed from the virtual viewpoint is complicated as information indicating the complicatedness of the object shape. Further, explanation is given on the assumption that the scheme setting unit 303 according to Embodiment 1 sets a predefined value or a value based on instructions from a user as the first threshold value (tₛ) at S604, but the setting method of the first threshold value (tₛ) is not limited to this. For example, it may also be possible for the scheme setting unit 303 to set the first threshold value (tₛ) by using mathematical formula (3).

tₛ=α·(d′/F′) mathematical formula (3)

Here, d′ is the distance from the imaging apparatus 101 to the center of the image capturing area 106, which is projected in the optical axis direction of the imaging apparatus 101, F′ is the focal length of the imaging apparatus 101, and a is an appropriate coefficient. In this case, it is preferable for the scheme setting unit 303 to calculate the first threshold value tₛ as follows. First, the scheme setting unit 303 selects the imaging apparatus 101 whose position and optical axis direction are similar to the position and the viewing direction of the virtual camera. Following this, the scheme setting unit 303 calculates the first threshold value tₛ by using the distance (d′) from the selected imaging apparatus 101 to the center of the image capturing area 106 and the focal length (F′) of the imaging apparatus 101.

Further, explanation is given on the assumption that the scheme setting unit 303 according to Embodiment 1 sets a rendering scheme based on the complicatedness of the object shape and the object size per pixel at S604, but the setting method of a rendering scheme is not limited to this. FIG. 8B and FIG. 8C each show one example of an LUT that is used in a case where the scheme setting unit 303 sets a rendering scheme and which is different from that in FIG. 8A. For example, it may also be possible for the scheme setting unit 303 to set a rendering scheme in accordance with only the level of the object size per pixel. Specifically, the scheme setting unit 303 sets the rendering scheme based on radiance fields in a case where the level of the object size per pixel is “small” and sets the rendering scheme based on shape in a case where the level is “large” as shown in FIG. 8B.

Further, for example, it may also be possible for the scheme setting unit 303 to set a rendering scheme in accordance with only the level of the complicatedness of the object shape. Specifically, the scheme setting unit 303 sets the rendering scheme based on radiance fields in a case where the level of the object shape is “complicated” and sets the rendering scheme based on shape in a case where the level is “simple” as shown in FIG. 8C. Further, for example, it may also be possible for the scheme setting unit 303 to select one of a plurality of the LUTs as shown in FIG. 8A to FIG. 8C in accordance with a predetermined condition and set a rendering scheme. Furthermore, for example, it may also be possible to select the setting method desired by a user from among a plurality of setting methods displayed on the display device 105 by the user operation and for the scheme setting unit 303 to set a rendering scheme based on the setting method selected by the user operation.

Further, in Embodiment 1, the aspect is explained as one example in which the scheme setting unit 303 sets the rendering scheme of a virtual viewpoint image based on the features of the one object 107 existing in the image capturing area 106 at S403. However, the number of objects of interest in a case where the rendering scheme of a virtual viewpoint image is set is not limited to one and it may also be possible for the scheme setting unit 303 to set the rendering scheme of a virtual viewpoint image based on the features of each of the plurality of objects. For example, it may also be possible for the scheme setting unit 303 to select the main object from among the plurality of objects included as images in the virtual viewpoint image and set the rendering scheme by performing the processing at S601 to S604 based on the features of the main object in a case of being viewed from the virtual viewpoint. Further, it may also be possible for the scheme setting unit 303 to set the rendering scheme of each object by performing the processing at S601 to S604 for each object.

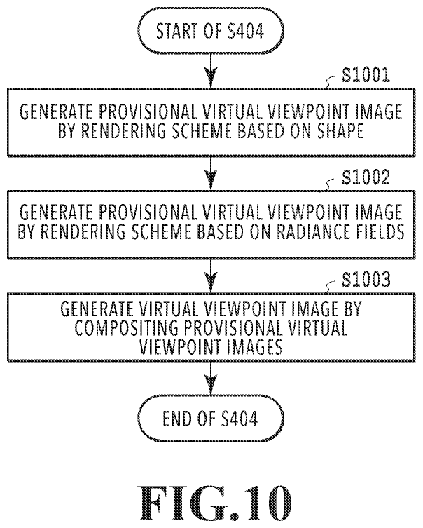

With reference to FIG. 10, a flow of the processing of the image generation unit 304 at S404 in a case where the scheme setting unit 303 performs the processing at S601 to S604 for each object is explained. FIG. 10 is a flowchart showing one example of a flow of the generation processing of a virtual viewpoint image in the image generation unit 304 according to Modification example 1 of Embodiment 1. Specifically, FIG. 10 is a flowchart showing one example of a flow of the generation processing of a virtual viewpoint image at S404 shown in FIG. 4 in a case where the scheme setting unit 303 performs the processing at S601 to S604 for each object. The image generation unit 304 generates a virtual viewpoint image by compositing a plurality of virtual viewpoint images generated by different rendering schemes for each object by performing the processing shown in the flowchart in FIG. 10.

First, at S1001, the image generation unit 304 generates, as in the processing at S902, a virtual viewpoint image corresponding to the object for which the rendering scheme based on shape has been set at S604 as a provisional virtual viewpoint image by the rendering scheme based on shape. Next, at S1002, the image generation unit 304 generates, as in the processing at S903, a virtual viewpoint image corresponding to the object for which the rendering scheme based on radiance fields has been set at S604 as a provisional virtual viewpoint image by the rendering scheme based on radiance fields. Next, at S1003, the image generation unit 304 generates a virtual viewpoint image by compositing a plurality of provisional virtual viewpoint images generated for each object by taking into consideration a relationship among objects about whether an object is located ahead of or behind another object. Specifically, in a case where a plurality of objects overlaps in a case of being viewed from the virtual viewpoint, a plurality of provisional virtual viewpoint images is composited so that the object located behind is shielded by the object located ahead. After the processing at S1003, the image generation unit 304 terminates the processing of the flowchart shown in FIG. 10, that is, the processing at S404.

Further, explanation is given on the assumption that the image generation unit 304 according to Embodiment 1 generates, at S902, a virtual viewpoint image corresponding to the virtual viewpoint based on the object approximate shape obtained at S601, but the generation method of a virtual viewpoint image is not limited to this. Specifically, it may also be possible for the image generation unit 304 to obtain the object approximate shape anew by the visual hull method without using the object approximate shape obtained at S601. Further, the obtaining method of the object approximate shape in the image generation unit 304 is not limited to the visual hull method.

For example, the object approximate shape may be obtained based on distance information obtained by stereo matching or the like from two captured images obtained by image capturing by the two imaging apparatuses 101 adjacent to each other, or distance image data obtained by measurement by a depth camera. Further, for example, it may also be possible for the image generation unit 304 to obtain the object approximate shape by reading the object approximate shape generated in advance and stored in the storage device 204 or the like. The image generation unit 304 generates a virtual viewpoint image corresponding to the virtual viewpoint based on the object approximate shape obtained anew as described above without using the object approximate shape obtained at S601.

Further, in Embodiment 1, explanation is given on the assumption that the radiance fields are represented by using one multilayer perceptron, but the representation method of the radiance fields is not limited to this. For example, the radiance fields may be one represented by using a plurality of multilayer perceptrons, or may be one represented by sparse three-dimensional grids including spherical harmonics, or may be one represented by using tensors

Further, in Embodiment 1, as one example, the aspect is explained in which the image processing apparatus 102 generates a virtual viewpoint image corresponding to one frame, but it may also be possible for the image processing apparatus 102 to generate virtual viewpoint images corresponding to a plurality of continuous frames. In this case, for example, the image processing apparatus 102 repeatedly performs the processing at S401 to S405 for each frame. Further, for example, it may also be possible for the image processing apparatus 102 to generate virtual viewpoint images corresponding to a plurality of fames after correcting the rendering scheme following the setting of the rendering scheme of virtual viewpoint images corresponding to a plurality of frames. In this case, it is preferable to correct the rendering scheme so that the rendering scheme does not switch to another in several continuous frames. For example, in a case where the rendering scheme based on shape is set in the frame of interest and the rendering scheme based on radiance fields is set in almost all the frames around the frame of interest, the image processing apparatus 102 corrects the rendering scheme as follows. Specifically, in this case, the image processing apparatus 102 corrects the rendering scheme in the frame of interest for which the rendering scheme based on shape is set, to the rendering scheme based on radiance fields.

Further, explanation is given on the assumption that the image processing apparatus 102 according to Embodiment 1 generates a virtual viewpoint image by the rendering scheme based on shape or the rendering scheme based on radiance fields, but the rendering scheme in the image processing apparatus 102 is not limited to those. For example, it may also be possible for the image processing apparatus 102 to generate a virtual viewpoint image by a rendering scheme based on image transformation. The rendering scheme based on image transformation is a scheme of generating a virtual viewpoint image by compositing a plurality of captured images transformed based on the image capturing camera parameters and the virtual camera parameters. Like the rendering scheme based radiance fields, the rendering scheme based on image transformation does not depend on the object approximate shape. Because of this, it may also be possible for the image processing apparatus 102 to generate a virtual viewpoint image by the rendering scheme based on image transformation by setting the rendering scheme based on image transformation in place of the rendering scheme based on radiance fields.

### Embodiment 2

In Embodiment 1, as one example, the case is explained where the focal length of all the imaging apparatuses 101 is equal (here, “equal” includes “substantially equal”). In Embodiment 2, a case is explained where the image processing system includes a plurality of imaging apparatuses whose focal lengths are different. The hardware configuration, the function configuration, and the processing flow of the image processing apparatus 102 according to Embodiment 2 are the same as those of Embodiment 1, and therefore, explanation is omitted. However, the image processing apparatus 102 according to Embodiment 2 (in the following, simply described as “image processing apparatus 102”) differs from the image processing apparatus 102 according to Embodiment 1 in the setting processing of the rendering scheme at S403 shown in FIG. 4. Consequently, in the following, the captured image and the setting processing of a rendering scheme are explained mainly. Explanation is given by attaching the same symbol to the same configuration as that of Embodiment 1.

### <Captured Image>

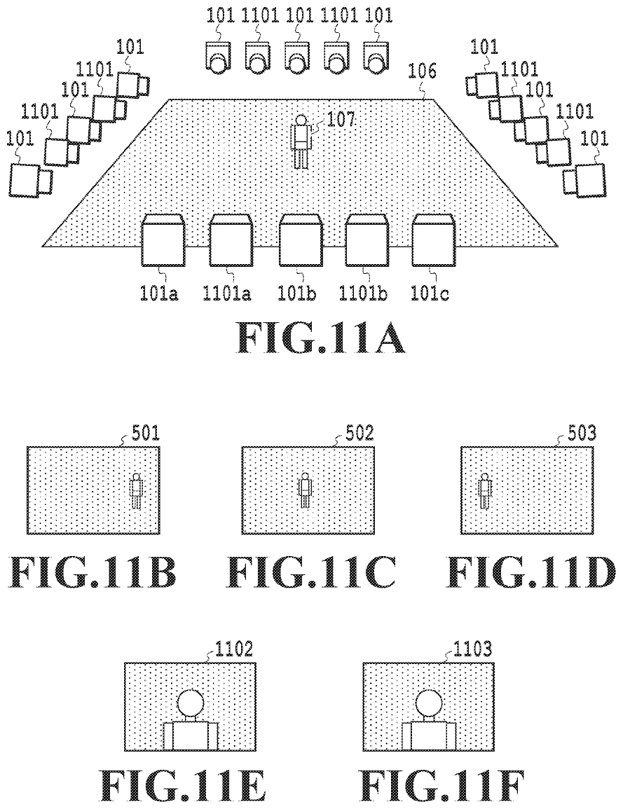

FIG. 11A is a diagram showing one example of the arrangement of the imaging apparatuses 101 and imaging apparatuses 1101 according to Embodiment 2 and FIG. 11B to FIG. 11F are each a diagram showing one example of a captured image that is obtained by image capturing of the imaging apparatuses 101 and 1101. FIG. 11A shows one example of the arrangement of each of the plurality of the imaging apparatuses 101 and a plurality of the imaging apparatuses 1101. As shown in FIG. 11A, in Embodiment 2, in addition to the imaging apparatuses 101 shown in FIG. 5A explained in Embodiment 1, the plurality of the imaging apparatuses 1101 whose focal length is longer than that of the imaging apparatus 101 is arranged so as to be capable of capturing the object 107 from a variety of directions. Imaging apparatuses 1101a and 1101b shown in FIG. 11A are the same as the other imaging apparatuses 1101.

FIG. 11B, FIG. 11C, and FIG. 11D are each a diagram showing one example of the captured image 501, one example of the captured image 502, and one example of the captured image 503 respectively in this order, which are obtained by the imaging apparatuses 101a, 101b, and 101c. The captured images 501, 502, and 503 are the same as the captured images 501, 502, and 503 shown in FIG. 5B to FIG. 5D, and therefore, explanation is omitted. FIG. 11E and FIG. 11F are each a diagram showing one example of a captured image 1102 and one example of a captured image 1103 respectively in this order, which are obtained by image capturing by the imaging apparatuses 1101a and 1101b. The focal length of the imaging apparatus 1101 is long compared to that of the imaging apparatus 101, and therefore, the object size per pixel of the captured images 1102 and 1103 is smaller than that of the captured images 501 to 503.

### <Setting Processing of Rendering Scheme>

The setting processing of a rendering scheme that the scheme setting unit 303 according to Embodiment 2 performs differs from the setting processing of a rendering scheme that the scheme setting unit 303 according to Embodiment 1 performs only in the processing at S604 shown in FIG. 6. In the following, the processing at S604 in the scheme setting unit 303 according to Embodiment 2 (in the following, simply described as “scheme setting unit 303”) is explained. At S604, the scheme setting unit 303 sets a rendering scheme of a virtual viewpoint image based on the object size per pixel and the information indicating the complicatedness of the object shape, in a case of being viewed from the virtual viewpoint. Specifically, the scheme setting unit 303 sets either the rendering scheme based on shape or the rendering scheme based on radiance fields as the rendering scheme of a virtual viewpoint image, based on the object size and the information indicating the complicatedness.

The quality of a virtual viewpoint image that the image processing apparatus 102 generates based on a captured image will be as follows in accordance with the features of the object in a case of being viewed from the virtual viewpoint. In a case where the object shape is complicated, the smaller the object size per pixel, the more the quality of a virtual viewpoint image by the rendering scheme based on shape is reduced. On the other hand, in this case, the reduction in quality of a virtual viewpoint image by the rendering scheme based on radiance fields is suppressed. Further, in a case where the object shape is simple and the object size per pixel is smaller than an average value of a captured image, the feeling of resolution of a virtual viewpoint image by the rendering scheme based on radiance fields is reduced. On the other hand, in this case, the reduction in quality of a virtual viewpoint image by the rendering scheme based on shape is suppressed. In a case of the conditions other than the above-described condition, the quality of a virtual viewpoint image by the rendering scheme based on shape and the quality of a virtual viewpoint image by the rendering scheme based on radiance fields are substantially equal to each other irrespective of the rendering scheme. Further, the amount of calculation necessary for generating a virtual viewpoint image with the rendering scheme based on shape is small compared to that with the rendering scheme based on radiance fields.

In view of theses, the scheme setting unit 303 sets a rendering scheme as follows. First, in a case where the object size(s) per pixel viewed from the virtual viewpoint is larger than or equal to a third threshold value (tₛ′), the scheme setting unit 303 judges that the level of the object size is “large”. Further, in a case where the object size(s) per pixel is larger than or equal to the first threshold value tₛ and less than the third threshold value (tₛ′), the scheme setting unit 303 judges that the level of the object size is “medium”. Further, in a case where the object size (s) per pixel is less than the first threshold value (tₛ), the scheme setting unit 303 judges that the level of the object size is “small”. Further, in a case where the value (c) indicating the complicatedness of the object shape viewed from the virtual viewpoint is larger than or equal to the second threshold value (t_{c}), the scheme setting unit 303 judges that the level of the complicatedness of the object shape is “complicated”. Further, in a case where the value (c) indicating the complicatedness of the object shape is less than the second threshold value (t_{c}), the scheme setting unit 303 judges that the level of the complicatedness of the object shape is “simple”. Furthermore, the scheme setting unit 303 sets the rendering scheme of a virtual viewpoint image in accordance with the level of the object size and the level of the complicatedness of the object shape.

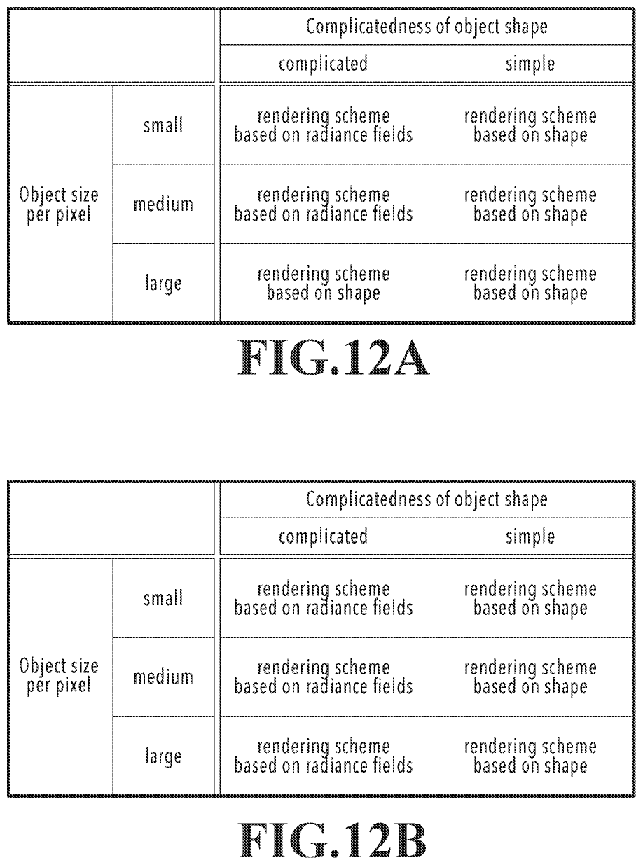

FIG. 12A and FIG. 12B are each a diagram showing one example of an LUT that the scheme setting unit 303 according to Embodiment 2 uses in a case of setting a rendering scheme. In the LUT shown in FIG. 12A and FIG. 12B, as in FIG. 8A to FIG. 8C, the rendering scheme, the level of the object size per pixel in a case of being viewed from the virtual viewpoint, and the level of the complicatedness of the object shape in a case of being viewed from the virtual viewpoint are managed in association with one another. The scheme setting unit 303 determines and sets the rendering scheme of a virtual viewpoint image in accordance with the level of the object size and the level of the complicatedness of the object shape by using the LUT shown in FIG. 12A.

Specifically, the scheme setting unit 303 sets the rendering scheme based on radiance fields as the rendering scheme of a virtual viewpoint image only in a case where the level of the complicatedness of the object shape is “complicated” and the level of the object size per pixel is less than or equal to “medium”. In the cases other than this case, the scheme setting unit 303 sets the rendering scheme based on shape as the rendering scheme of a virtual viewpoint image. The first threshold value (tₛ), the third threshold value (tₛ′), and the second threshold value (t_{c}) may be predefined values or values that are set based on instructions from a user, which are obtained via the UI panel 103 or the like. For example, it is preferable to set the same value as that of Embodiment 1 for the first threshold value (tₛ) and the second threshold value (t_{c}) and set a value based on an average object size per pixel of a plurality of captured images for the third threshold value tₛ′. The LUT shown in FIG. 12B will be described later.

<Effects Brought about by the Image Processing Apparatus According to Embodiment 2>

As above, the image processing apparatus 102 is configured so as to set either the rendering scheme based on shape or the rendering scheme based on radiance fields as the rendering scheme of a virtual viewpoint image based on the features of the object 107 in a case of being viewed from the virtual viewpoint. Specifically, the image processing apparatus 102 is configured so that the more complicated the object shape in a case of being viewed from the virtual viewpoint, or the smaller the object size per pixel in a case of being viewed from the virtual viewpoint, the more preferentially the rendering scheme based on radiance fields is set. On the other hand, the image processing apparatus 102 is configured so that the simpler the object shape in a case of being viewed from the virtual viewpoint, or the larger the object size per pixel in a case of being viewed from the virtual viewpoint, the more preferentially the rendering scheme based on shape is set. According to the image processing apparatus 102 configured as above, even in a case where the imaging apparatuses 101 and 1101 whose focal lengths are different from one another are included, it is possible to improve the image quality of a virtual viewpoint image that is obtained by rendering. Further, according to this image processing apparatus 102, it is possible to suppress the feeling of incongruity of a viewer for the image of the object 107 in a case where the virtual viewpoint image is viewed.

### Modification Example 1 of Embodiment 2

The scheme setting unit 303 according to Embodiment 2 sets a rendering scheme based on the level of the complicatedness of the object and the level of the object size per pixel at S604, but the setting method of a rendering scheme is not limited to this. FIG. 12B shows one example of the LUT that the scheme setting unit 303 uses in a case of setting a rendering scheme and which is different from that in FIG. 12A. For example, it may also be possible for the scheme setting unit 303 to set a rendering scheme in accordance with only the level of the complicatedness of the object shape. Specifically, for example, as shown in FIG. 12B, the scheme setting unit 303 sets the rendering scheme based on radiance fields in a case where the level of the complicatedness of the object shape is “complicated” and sets the rendering scheme based on shape in a case where the level is “simple”.

Further, explanation is given on the assumption that the image processing apparatus 102 according to Embodiment 2 sets the rendering scheme of a virtual viewpoint image by using the captured images obtained by capturing the object 107 from a variety of directions by using the imaging apparatuses 101 and 1101 whose focal lengths are different from one another. However, the setting method of a rendering scheme in the image processing apparatus 102 is not limited to this.

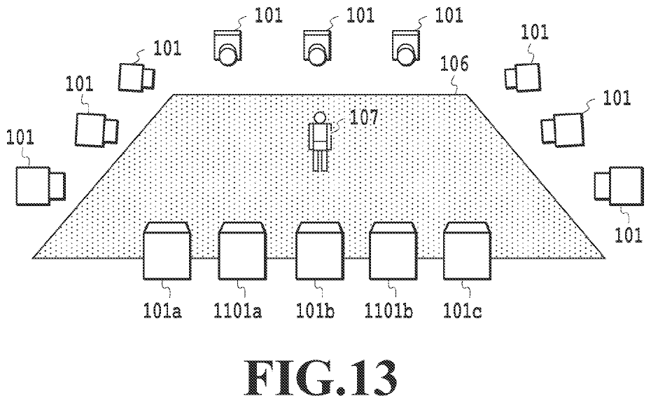

FIG. 13 is a diagram showing one example of the arrangement of the imaging apparatuses 101 and 1101 according to Modification example 1 of Embodiment 2. Specifically, in FIG. 13, the imaging apparatuses 101 and 1101 whose focal lengths are different from one another only in a specific direction are arranged. It is possible to apply the image processing apparatus 102 also to a case where the imaging apparatuses 101 and 1101 whose focal lengths are different from one another are arranged unevenly as shown in FIG. 13. In this case, for example, the image processing apparatus 102 switches the setting method of a rendering scheme to another in accordance with whether or not the direction of the virtual viewpoint is the direction in which the imaging apparatuses 101 and 1101 whose focal lengths are different from one another are arranged. Specifically, the image processing apparatus 102 sets a rendering scheme based on the LUT shown in FIG. 12A or FIG. 12B in a case where the direction of the virtual viewpoint is the direction in which the imaging apparatuses 101 and 1101 whose focal lengths are different from one another are arranged. On the other hand, in a case where the direction of the virtual viewpoint is the direction in which the imaging apparatuses 101 whose focal length is identical to one another are arranged, the image processing apparatus 102 sets a rendering scheme based on the LUT shown in one of FIG. 8A to FIG. 8C.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the technique of the present disclosure, it is possible to improve the image quality of a virtual viewpoint image.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-200974, filed Nov. 28, 2023 which is hereby incorporated by reference wherein in its entirety.

What is claimed is:

1. An image processing apparatus comprising:
one or more hardware processors; and
one or more memories storing one or more programs configured to be executed by the one or more hardware processors, the one or more programs including instructions for:
obtaining data of a plurality of captured images obtained by capturing an object from a plurality of directions;
obtaining virtual viewpoint information relating to a position of a virtual viewpoint and a viewing direction at the virtual viewpoint;
setting a generation scheme of a virtual viewpoint image based on features of the object, which are obtained based on the virtual viewpoint information; and
generating the virtual viewpoint image based on the virtual viewpoint information and the set generation scheme of the virtual viewpoint image.

2. The image processing apparatus according to claim 1, wherein
the one or more programs further include instructions for:
setting either a rendering scheme based on shape or a rendering scheme based on radiance fields as the generation scheme of the virtual viewpoint image.

3. The image processing apparatus according to claim 2, wherein
the rendering scheme based on shape is a scheme in which rendering is performed based on information indicating a three-dimensional shape of the object, which is generated by using the plurality of captured images by a visual hull method, and data of the plurality of captured images.

4. The image processing apparatus according to claim 2, wherein
the radiance fields are a function that is estimated as results of performing repetitive processing so that a difference between a pixel value in the plurality of captured images and a pixel value obtained by volume rendering based on the radiance fields becomes small and
the rendering scheme based on radiance fields is a scheme in which rendering is performed by inputting the virtual viewpoint information to the function indicating the radiance fields.

5. The image processing apparatus according to claim 2, wherein
the features of the object are complicatedness of the shape of the object in a case where the object is viewed from the virtual viewpoint and
the one or more programs further include instructions for:
setting, the more complicated the object shape, the more preferentially the rendering schemed based on radiance fields as the generation scheme of the virtual viewpoint image.

6. The image processing apparatus according to claim 2, wherein
the features of the object are a size of the object per pixel in the virtual viewpoint image in a case where the object is viewed from the virtual viewpoint and
the one or more programs further include instructions for:
setting, the smaller the object size per pixel, the more preferentially the rendering scheme based on radiance fields as the generation scheme of the virtual viewpoint image.

7. The image processing apparatus according to claim 2, wherein
the features of the object are complicatedness of the object shape and the size of the object per pixel in the virtual viewpoint image in a case where the object is viewed from the virtual viewpoint and
the one or more programs further include instructions for:
setting, the more complicated the object shape and the smaller the object size per pixel, the more preferentially the rendering scheme based on radiance fields as the generation scheme of the virtual viewpoint image.

8. The image processing apparatus according to claim 1, wherein
the one or more programs further include instructions for:
selecting, in a case where a plurality of the objects included as an image in the plurality of captured images exists, one of the plurality of the objects that exist as a representative object and
setting the generation scheme of the virtual viewpoint image based on the features of the representative object in a case where the representative object is viewed from the virtual viewpoint.

9. The image processing apparatus according to claim 1, wherein
the one or more programs further include instructions for:
setting, in a case where a plurality of the objects included as an image in the plurality of captured images exists, the generation scheme of the virtual viewpoint image based on the features of the object in a case where the object is viewed from the virtual viewpoint for each of the objects;
generating a plurality of provisional virtual viewpoint images by a plurality of generation schemes different from one another based on the generation scheme set for each of the objects; and
generating the virtual viewpoint image by compositing the plurality of the generated provisional virtual viewpoint images.

10. The image processing apparatus according to claim 9, wherein
the one or more programs further include instructions for:
compositing, in generating the virtual viewpoint image, the plurality of the generated provisional virtual viewpoint images based on overlapping in a case of being viewed from the virtual viewpoint of the plurality of the objects that exist.

11. An image processing method comprising the steps of:
obtaining data of a plurality of captured images obtained by capturing an object from a plurality of directions;
obtaining virtual viewpoint information relating to a position of a virtual viewpoint and a viewing direction at the virtual viewpoint;
setting a generation scheme of a virtual viewpoint image based on features of the object, which are obtained based on the virtual viewpoint information; and
generating the virtual viewpoint image based on the virtual viewpoint information and the set generation scheme of the virtual viewpoint image.

12. A non-transitory computer readable storage medium storing a program for causing a computer to perform a control method of an image processing apparatus, the control method comprising the steps of:
obtaining data of a plurality of captured images obtained by capturing an object from a plurality of directions;
obtaining virtual viewpoint information relating to a position of a virtual viewpoint and a viewing direction at the virtual viewpoint;
setting a generation scheme of a virtual viewpoint image based on features of the object, which are obtained based on the virtual viewpoint information; and
generating the virtual viewpoint image based on the virtual viewpoint information and the set generation scheme of the virtual viewpoint image.
